(19) United States
(12) Patent Application Publication
(10) Pub. No.: US 2009/0159826 A1
(43) Pub. Date: Jun. 25, 2009

(54) VALVE

(76) Inventors: Geoff Wayne Poulton, Victoria (AU); Michael Kirby, New South Wales (AU); Allan Dolph Meyer, New South Wales (AU)

Correspondence Address: MILES & STOCKBRIDGE PC, 1751 PINNACLE DRIVE, SUITE 500, MCLEAN, VA, 22102-3833, US

(21) Appl. No.: 12/094,140

(22) PCT Filed: Nov. 18, 2005
(86) PCT No.: PCT/AU05/01762

§ 371 Date: Oct. 1, 2008

(30) Foreign Application Priority Data
Nov. 19, 2004 (AU) 2004906644

(51) Int. Cl. F16K 25/00

(52) U.S. Cl. 251/157

(57) ABSTRACT

The present invention relates broadly to a valve (10) comprising a valve body (14) connected to a valve member (16). The present invention relates broadly to a valve (10) comprising a valve body (14) connected to a valve member (16). The valve body (14) includes a fluid passageway (18) across which the valve member (16) is connected. The valve member (16) includes a plurality of valve elements such as (20A and 20C) which are moveably coupled to the valve body (14) to permit opening and closure of the valve (10). The valve member (16) includes a collapsible opening (22) located at or adjacent an apex of the conical-shaped valve member (16). The valve (10) includes a series of resilient hinges such as (30A and 30C) disposed about a perimeter of the valve member (16). The resilient hinges (30A and 30C) are substantially straight and configured to minimise the force required in deflecting the valve elements such as (20A) to open valve member (16) and expose the collapsible aperture (22).

### FIELD OF THE INVENTION

The present invention relates broadly to a valve and relates particularly, though not exclusively, to a non-return valve, check valve or backflow prevention valve.

### BACKGROUND OF THE INVENTION

Check valves of a duckbill configuration are relatively well known and used in the art of valves. The patent literature has a large number of patents disclosing duckbill valves including U.S. Pat. Nos. 3,901,272, 4,524,805, 3,822,720, 4,240,630 and 6,089,260. These patents similarly disclose a valve of a duckbill form having a slit at its outlet. The slit is designed to elastically deform and open when tension is applied about is periphery whereas closure of the slit is automatically provided by biasing stresses in the valve as a consequence of its shape.

The prior art of U.S. Pat. No. 996,588 and German patent no. 4,033,818 describe variants of the duckbill check valves of the preceding art. Both U.S. Pat. No. 996,588 and DE 4,033,818 are valves of a generally conical shape designed to permit flow in a single direction only. U.S. Pat. No. 996,588 is a check valve with a transverse slit through a relatively thick apex portion of the valve which is tensioned under fluid pressure to elastically deform and open. DE 4,033,818 is a pressure relief valve having a discharge aperture at its apex which opens and releases pressure at a predetermined pressure. The valve of DE 4,033,818 is constructed of a highly elastic synthetic resin or rubber which is biased closed but under pressure is stressed about the discharge aperture which is opened.

The applicants (or their predecessors) of international patent application no. PCT/AU00/00659 disclose a non-return valve having a valve diaphragm of a conical-shape. The valve diaphragm which is constructed of a resiliently flexible material includes a collapsible aperture which is exposed so as to open under fluid pressure on an upstream side of the valve. The valve diaphragm is tensioned or stressed about the collapsible aperture and the wall thickness of the diaphragm is reduced toward its apex to facilitate this opening of the valve.

These check or non-return valves suffer from at least the following problems:
(i) the differential pressure required across the valve to effect its opening is relatively high;
(ii) the valve may be designed to reduce this differential pressure for opening but then is less resistant to reverse flow pressures; and
(iii) the valve in its open condition does not provide great flow throughputs as the throat restriction of the slit or collapsible opening is relatively high.

### SUMMARY OF THE INVENTION

According to one aspect of the present invention there is provided a valve comprising:
a valve body including a fluid passageway and being adapted for mounting of the valve; and
a valve member connected to the valve body across the fluid passageway, the valve member including an opening defined by one or more valve elements being moveable relative to the valve body whereby opening and/or closure of the opening is effected by bending of said one or more valve elements about respective associated and substantially straight resilient hinges.

Preferably the valve body is shaped substantially cylindrical and the valve member is symmetrical about the valve body. More preferably the valve member is in the form of a cone or conical-frustum, pyramid or pyramidal-frustum, being directed in a downstream flow direction.

According to another aspect of the invention there is provided a valve comprising:
a valve body including a fluid passageway and being adapted for mounting of the valve; and
a valve member connected to the valve body across the fluid passageway, the valve member including an opening which is exposed by bending of at least part of said member about an associated resilient hinge which provides minimal stressing of said member.

Preferably the opening is defined by one or more valve elements being movable relative to the valve body.

Preferably the valve member includes one or more slits dividing it into a plurality of said valve elements each being of a substantially identical configuration. More preferably each of the plurality of valve elements is arranged to bend or hinge about respective resilient hinges each adjoining the valve body and the valve member. Even more preferably the valve member includes two (2) of the slits arranged perpendicular to one another and intersecting at an axis of the valve body, the slits terminating at or adjacent opposite ends of the resilient hinge of the corresponding valve element.

Preferably the valve member includes an annular seating portion being adapted to abut a corresponding surface of a valve housing whereby, on closure of the valve, further bending of said one or more valve elements is inhibited increasing the reverse flow resistance of the valve. More preferably the thickness of the valve member at the annular seating portion is at least two times the thickness of the resilient hinge.

Preferably the resilient hinge is defined by an annular groove formed in the valve body and is of a thickness less than adjacent portions of the valve body and the valve member to provide preferential bending of the valve elements about their respective hinges. More preferably the thickness of the resilient hinge is tailored to allow opening of the valve at a minimum fluid pressure. Even more preferably the resilient hinge permits opening of the valve at a differential pressure of less than around 10% of the fluid static pressure.

Preferably the valve also comprises one or more biasing elements each connected to the valve body and arranged on closure of the valve to contact the valve member for sealing closure at relatively low differential pressures. More preferably the biasing element is in the form of a lug connected to and projecting inwardly of the valve body, the lug being aligned with a corresponding recess in the valve body. Even more preferably the lug at least in part deflects into the recess on opening of the valve.

According to a further aspect of the invention there is provided a valve comprising:
a valve body including a fluid passageway and being adapted for mounting of the valve within a valve housing; and
a valve member connected to the valve body across the fluid passageway, the valve member including an opening defined by one or more valve elements being moveable relative to the valve body, the valve member also including a seating portion being adapted on closure of the valve to abut a corresponding surface of the valve housing whereby further movement of said one or more valve elements is inhibited increasing the reverse flow resistance of the valve.

Preferably the seating portion is an annular seating portion.

Preferably the valve elements are each tapered in thickness toward an apex of the valve member. More preferably the valve elements are flared or bulged inwardly toward the axis of the valve body.

Preferably the opening is a collapsible opening. More preferably the valve member when open defines a throat representing greater than around 40% of the area of the fluid passageway.

Preferably the valve member is in the form of a cone or conical-frustum, pyramid or pyramidal-frustum, being directed in a downstream flow direction.

Preferably the valve is a non-return valve, check valve, or backflow prevention valve.

Preferably the valve is a one-piece moulding being constructed or fabricated of an elastomeric or polymeric material.

### BRIEF DESCRIPTION OF THE FIGURES

In order to achieve a better understanding of the nature of the present invention several preferred embodiments of a valve will now be described in some detail, by way of example only, with reference to the accompanying drawings in which:

FIG. 1 is a cross-sectional view of one embodiment of a valve according to the invention;

FIG. 2 is a plan view of the valve of FIG. 1 viewed from a downstream side of the valve;

FIG. 3 is a perspective view of the valve of FIGS. 1 and 2;

FIG. 4 is a cross-sectional view of a valve according to another embodiment of the invention;

FIGS. 5A and 5B are respective plan (from an upstream side of the valve) and sectional views of a Finite Element Analysis (FEA) showing internal stresses of the valve of FIGS. 1 to 3 in the closed condition and under reverse flow pressure;

FIGS. 6A and 6B are respective plan (from an upstream side of the valve) and sectional views of a FEA showing displacement of the valve under the same conditions as in FIGS. 5A and 5B;

FIGS. 7A and 7B are respective plan (from an upstream side of the valve) and sectional views of a FEA showing internal stresses of the valve of FIGS. 1 to 3 in the open condition;

FIGS. 8A and 8B are respective plan (from an upstream side of the valve) and sectional views of a FEA showing displacement of the valve under the same conditions as in FIGS. 7A and 7B; and

FIG. 9 shows plan and cross-sectional views of two (2) variants of embodiments of a valve according to the invention.

### DETAILED DESCRIPTION OF THE PREFERRED EMBODIMENT

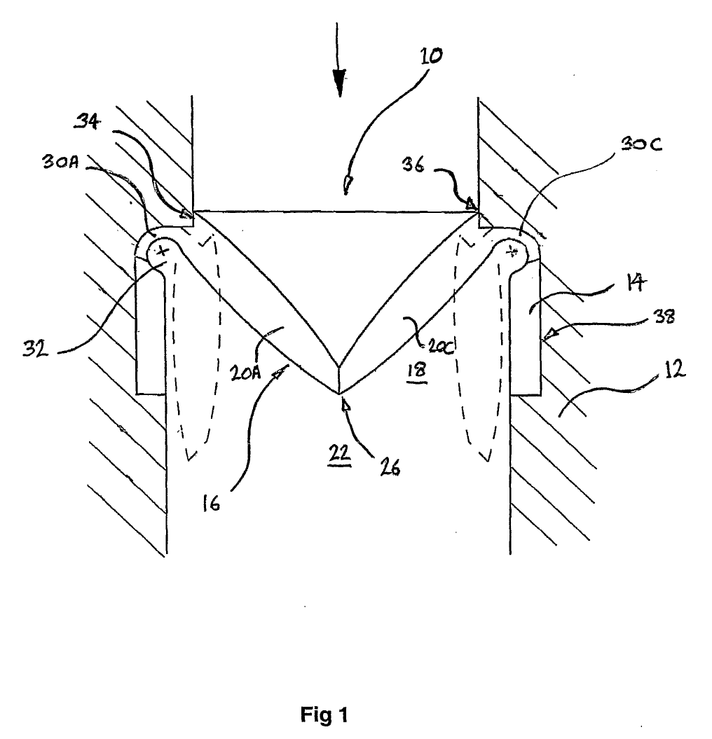

As best shown in FIG. 1, there is a valve in the form of a non-return or backflow prevention valve 10 mounted within a valve housing which in this application is a pipe 12. The valve 10 of this example is designed for installation as a water valve which may be installed in the pipe 12 upstream of a water meter (not shown). However, it will be appreciated that the valve 10 may have other applications including but not limited to pneumatic valves in balls and tires, industrial and domestic check valves, and non-return valves in plumbing installations. The valve 10 may also have biological or anatomical application in for example the human body such as an artificial heart valve.

The valve 10 comprises a valve body 14 connected to a valve member designated generally as 16. The valve body 14 is in this embodiment shaped substantially cylindrical and includes a fluid passageway 18 across which the valve member 16 is connected. The valve member 16 includes a plurality of valve elements such as 20A and 20C which are movably coupled to the valve body 14 to permit opening and closure of the valve 10. The solid line representation of the valve member 16 depicts the valve 10 in its closed configuration whereas the broken line detail shows the valve 10 in its open configuration whereby an opening in the form of a collapsible opening 22 of the valve member 16 is exposed.

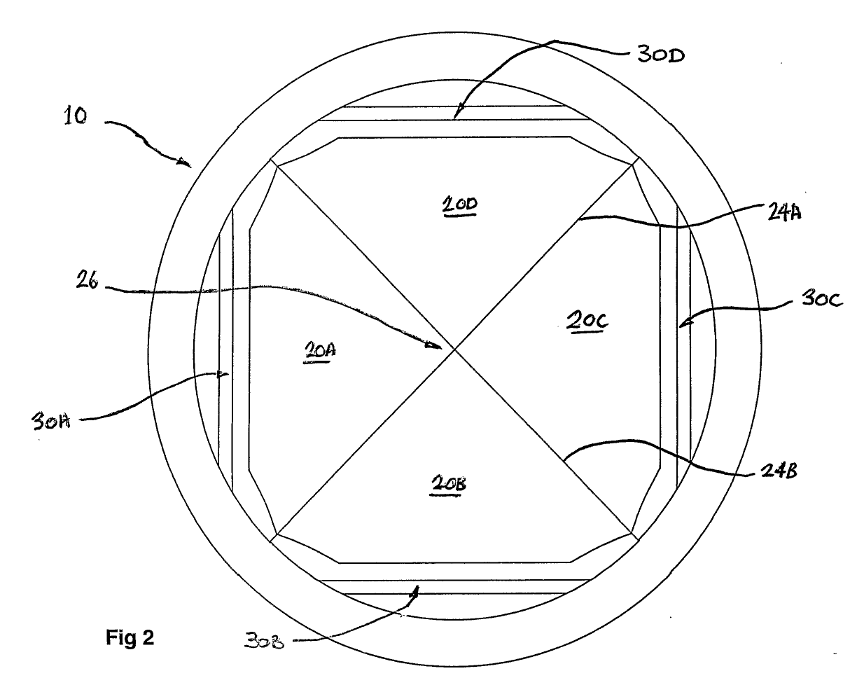

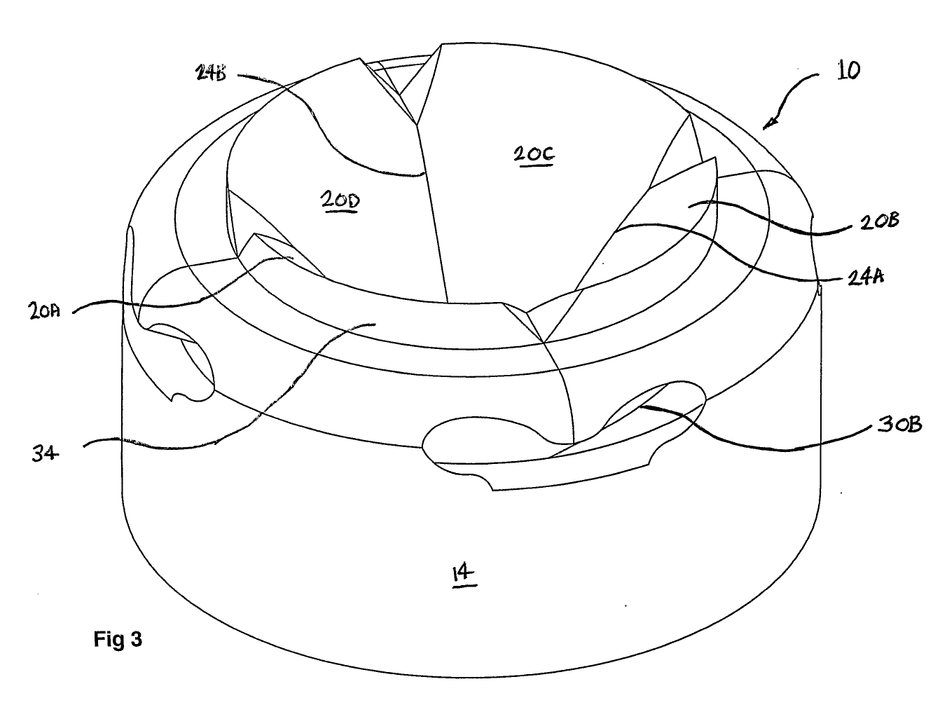

As best shown in FIGS. 2 and 3, the valve member 16 includes four (4) of the valve elements 20A to 20D each being of a substantially identical triangular configuration. The triangular valve elements 20A to 20D together and at least in part define the valve member 16 which in this example is of a generally conical shape. The valve elements 20A to 20D are formed by a pair of slits 24A and 24B arranged perpendicular to one another and intersecting at an apex 26 of the conical valve member 16. The valve elements such as 20A are each tapered in thickness toward the apex 26.

As best shown in FIG. 1, the valve member 16 in opening allows pivotal movement or bending of each of the triangular valve elements such as 20A and 20C about respective resilient hinges such as 30A and 30C. The resilient hinges 30A and 30C are in this embodiment substantially straight. As shown in FIGS. 2 and 3, the substantially straight resilient hinges 30A to 30B of the respective valve elements 20A to 20D are together of a generally square or orthogonal shape. The perpendicular slits 24A and 24B terminate at or adjacent “corners” of the square-shaped hinges 30A to 30D. This particular configuration is designed to minimise the force required in deflecting the valve elements such as 20A to open the valve member 16 and expose the collapsible aperture 22.

As best shown in FIG. 1, the resilient hinge such as 30A is defined by an internal annular groove 32 formed in the cylindrical valve body 14. The annular groove 32 ensures the resilient hinge such as 30A is of a thickness less than adjacent portions of the valve body 14 and the valve member 16 thereby providing preferential movement of the valve elements 20A to 20D about their respective hinges 30A to 30D. In this example the resilient hinge such as 30A is at least half the thickness of adjacent portions of the valve body 14 and the valve member 16.

The valve member 16 includes an annular seating portion 34 being adapted to abut a corresponding surface 36 of the valve housing or an inner wall surface of the pipe 12. The annular seating portion 34 is substantially circular in profile and raised at an upstream end of the valve 10. In this embodiment the valve body 14 together with at least part of the resilient hinge 30A to 30D is seated within a corresponding rebate 38 formed in the pipe 12. The abutment surface 36 and rebate 38 are together configured, on closure of the valve 10, to inhibit further bending or pivotal movement of the valve elements 20A to 20D wherein the annular seating portion 34 acts as a “wedge lock”. This arrangement strengthens the valve 10 to prevent it deforming beyond its point of resilience and provides support to the valve 10 which may otherwise collapse in a reverse flow direction. The thickness of the valve member 16 or respective valve elements such as 20A in the vicinity of the annular seating portion 34 is at least two times the thickness of the resilient hinge such as 30A.

The combination of the resilient hinges such as 30A to 30D and the “wedge lock” arrangement of the valve member 16 provides opening of the valve 10 with minimal differential pressure whilst providing effective closure under relatively high backflow pressure. The valve lo in the form of a non-return valve may be installed in a hot water system having the following parameters and requirements:
i. continuous working pressure of around 1,400 kPa in a forward flow direction;
ii. reverse flow pressure testing under 1,400 kPa;
iii a maximum differential pressure not exceeding around 10 kPa (which represents about 7% of the fluid static pressure);
iv. a closure pressure of around 3.5 kPa whereby the valve remains closed with this pressure on an upstream side of the valve;
v. a flow rate of 12 L/min;
vi. satisfy endurance testing at 1,400 kPa back pressure over 300,000 cycles.

The valve in the alternate form of a backflow prevention valve displays respective characteristics of: i) 1,400 kPa; ii) 2,000 kPa; iii) 50 kPa (or 2.5%); iv) less than 7 kPa; v) 42 L/min; and vi) 2,000 kPa and 50,000 cycles.

It will be appreciated that the characteristics of the valve 10 can be varied from that described by tailoring the valve geometry and dimensions and, in particular, by varying the thickness of the resilient hinges such as 30A to 30D. It will also be appreciated that opening of the valve 10 is possible at relatively low differential pressures by configuring the valve member 16 and in particular the resilient hinges 30A to 30D whereby minimal stresses are imparted to the valve member 16 on opening of the collapsible opening 22.

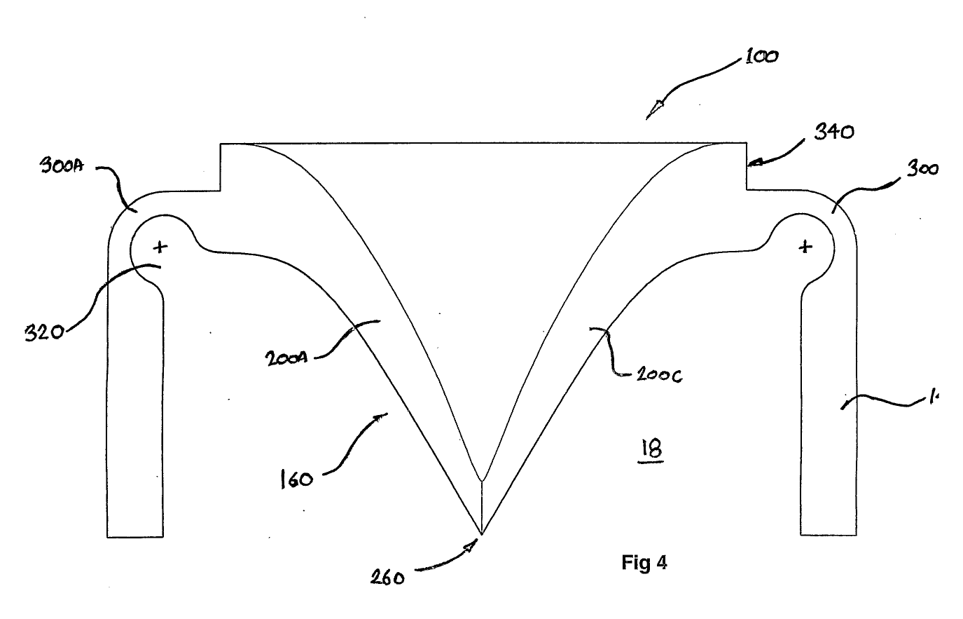

FIG. 4 is a cross-sectional view of a variant of the valve 10 of the preceding embodiment of the invention. This alternative valve 100 is similar to the preceding valve 10 except for the shape of the valve member 160. For ease of reference and in order to avoid repetition, like components of this alternate valve 100 have been designated with an additional “0” such as the valve body 140. The valve member 160 is of a generally conical configuration but with each of the valve elements such as 200A and 200C being bulged inwardly toward the axis of the valve body 140. The valve elements such as 200A and 200C provide increased resistance to inadvertent opening of the collapsible aperture 22 under excessive backflow pressures.

The valves such as 10 and 100 are preferably moulded or cast in one-piece from an elastomeric or polymeric material. In the described examples the valve such as 10 or 100 is injection moulded from rubber or silicone. The slits are generally formed after moulding of the valve such as 10 and 100 using a slitting jig or template (not shown).

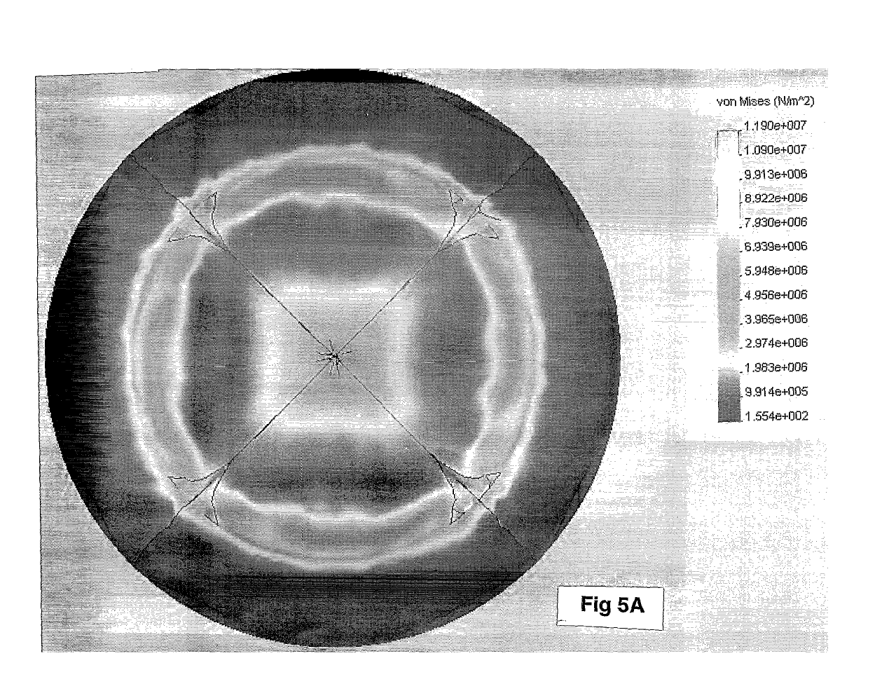

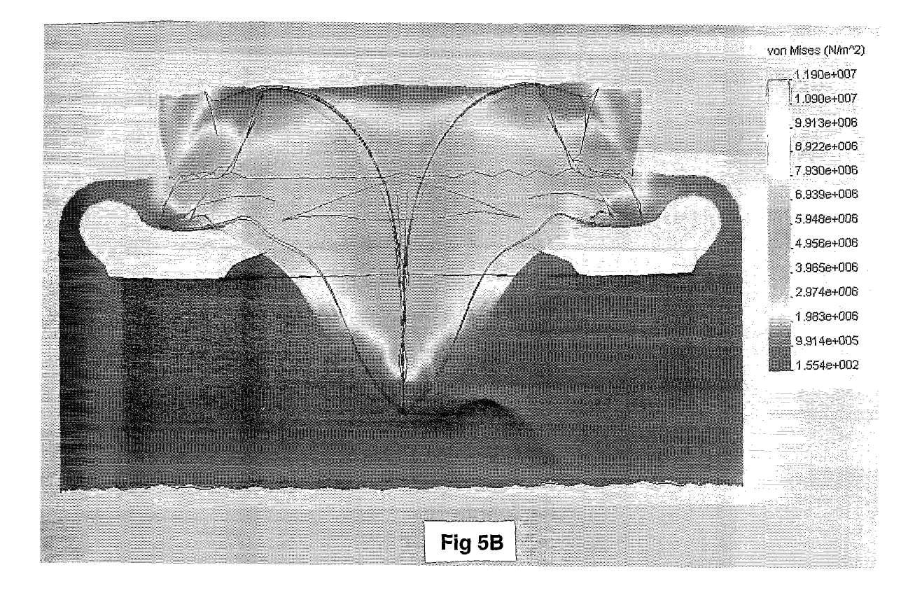

FIGS. 5 to 8 are Finite Element Analysis FEA in various views of the non-return valve 10 of FIGS. 1 to 3. The FEA illustrates the internal stresses and displacement of the valve 10 in its open and closed conditions. These displacements and stresses are represented by colours which accord with a coloured scale on the right hand side of each representation. The coloured scale depicts either internal valve stresses in N/m² or displacement in millimetres (mm).

FIGS. 5A and 5B illustrate the valve internal stresses in its closed condition under a reverse pressure of around 2,000 kPa. It can be seen that the maximum internal stresses depicted by areas of green are experienced around the annular seating portion 34 and in the vicinity of the apex 26 of the valve elements. The maximum internal stresses are up around 6 MPa.

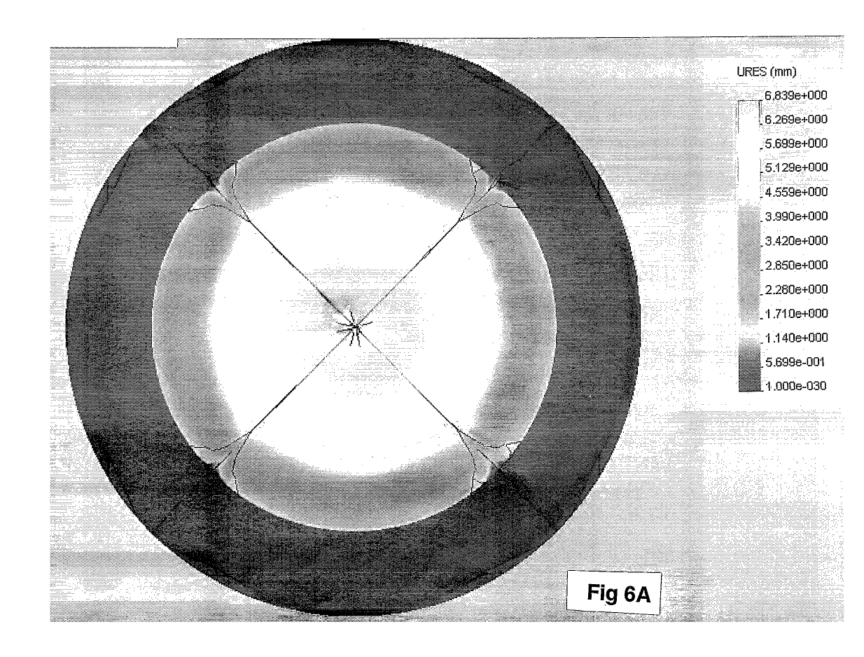

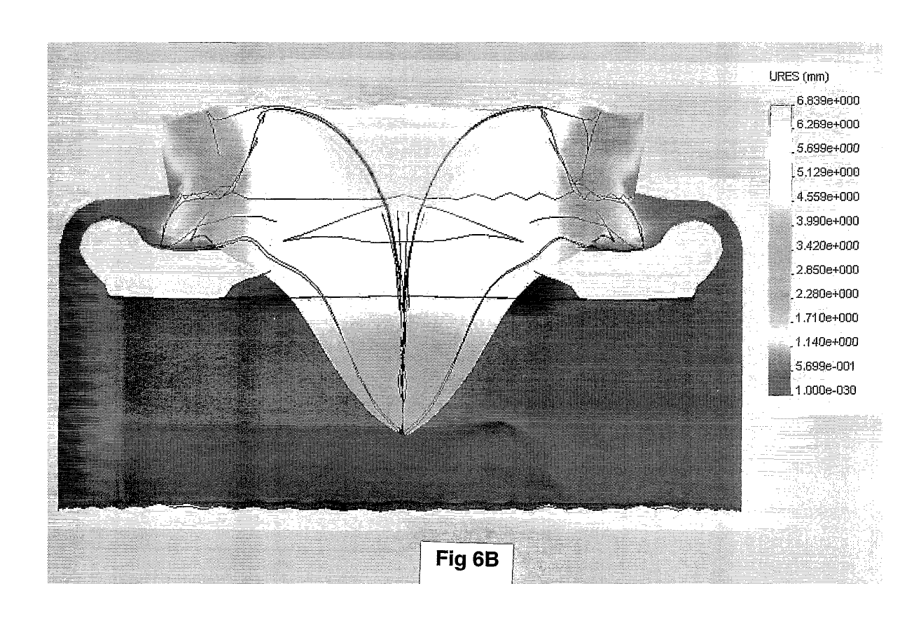

FIGS. 6A and 6B are FEA's corresponding to the modelling of figures 5A and 5B showing displacement of the valve 10 in its closed condition at the reverse fluid pressure of 2,000 kPa. As will be apparent from the displacement of the valve elements themselves, maximum displacement of the valve is experienced around the periphery of the valve elements inside and adjacent the annular seating portion. This maximum displacement is represented in red and is up around 6.8 mm.

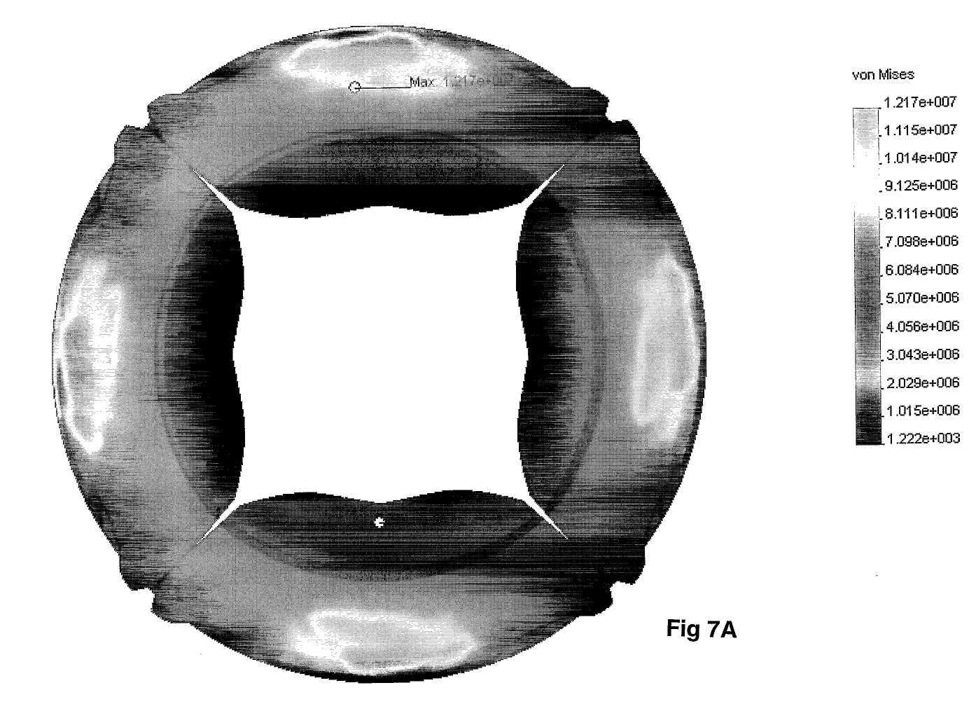

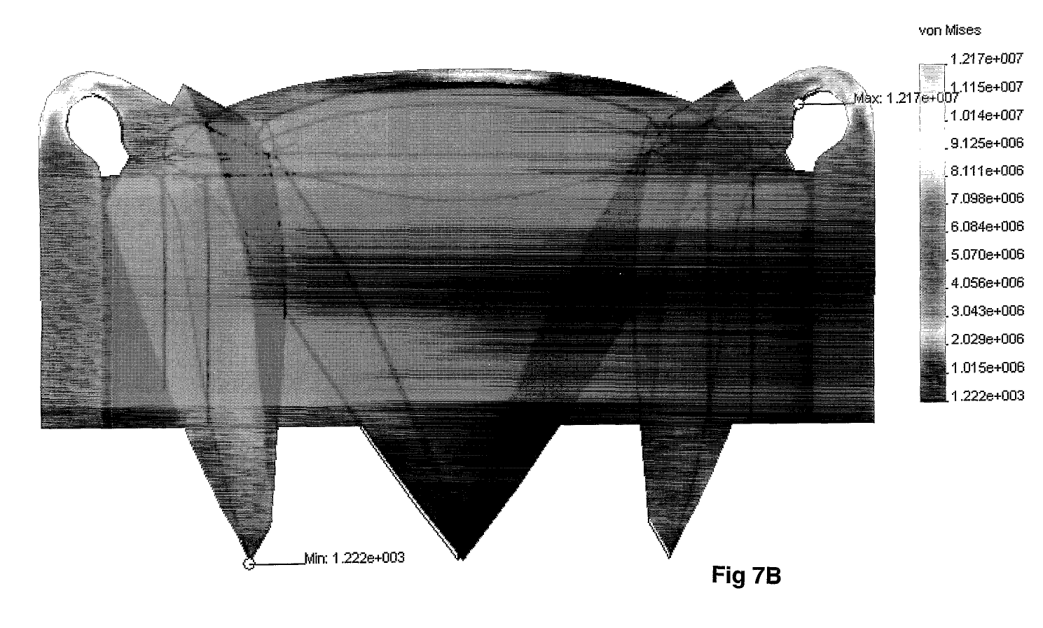

FIGS. 7A and 7B are FEAs showing the valve internal stresses in its open condition. The internal stresses depicted by the predominantly dark blue regions around the resilient hinges of the valve are up around 1 to 3 MPa. The areas of low stress are shown in deep blue and it is interesting to note that stresses of only around 1.2 kPa are experienced about the periphery of the collapsible opening around an apex of the valve elements. Importantly, the internal stresses in and around the pivot axes or hinges of the valve are nonetheless relatively low requiring reduced pressure and force to open the valve.

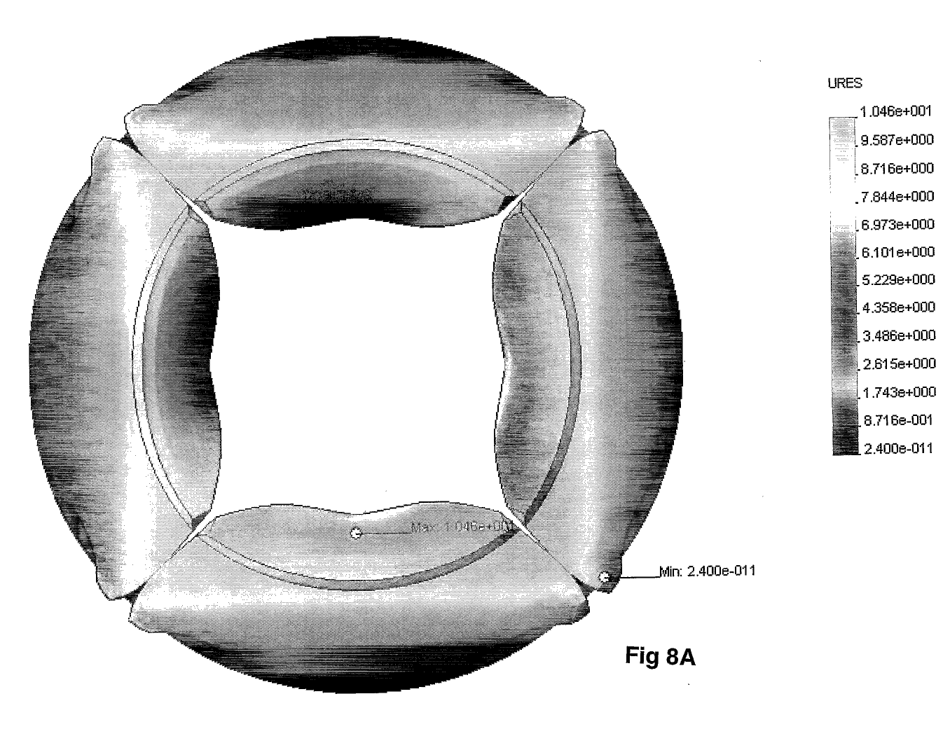

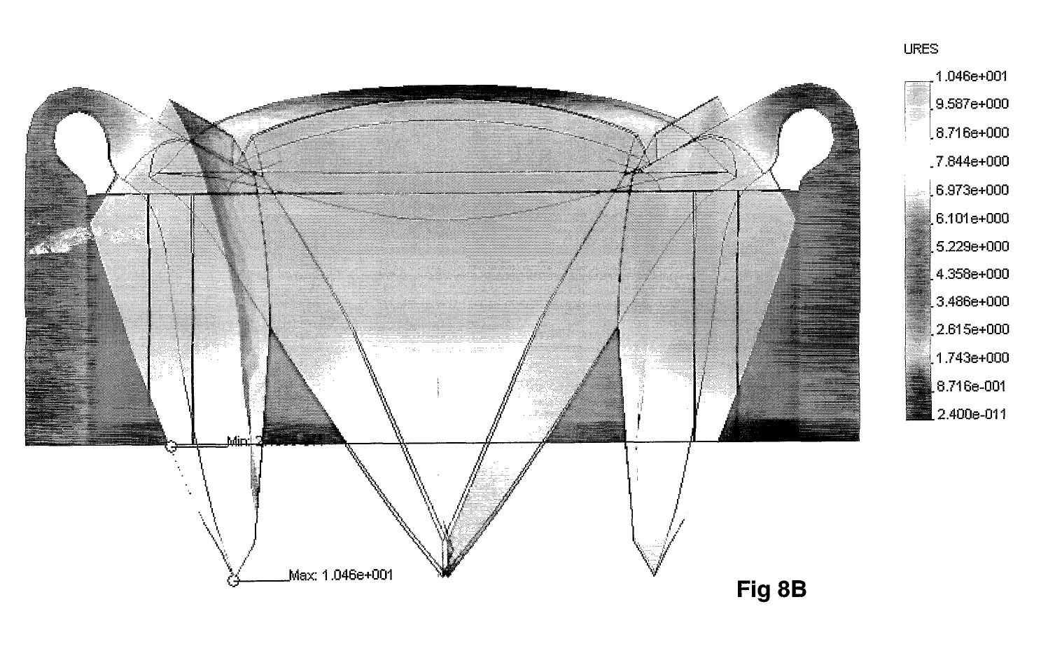

FIGS. 8A and 8B are FEAs corresponding to the modelling of FIGS. 7A and 7B showing displacement of the valve 10 in its open condition. As would ordinarily be expected, maximum displacement of the valve is displayed at the apex portions of each of the valve elements. In this example this maximum displacement is represented in red and is up around 10.4 mm. Importantly, FIG. 8A shows a zone of minimum displacement about the resilient hinges of the valve. This zone is generally depicted by the four (4) straight lines shown in hidden detail where the light blue zone transitions to the dark blue zone.

The FEA of FIGS. 5 to 8 illustrate the following important characteristics of the valve of this preferred embodiment:
1. the valve can be actuated with minimal differential pressure wherein the internal stresses in and around the resilient pivot axes or hinges is relatively low;
2. the valve under reverse flow conditions at relatively high pressures provides effective closure of the collapsible opening aided by the “wedge lock” effect where the annular seating surface abuts the valve housing.

These valves characteristics can be changed and tailored according to the particular application by varying the geometry of the valve and in particular the resilient hinge.

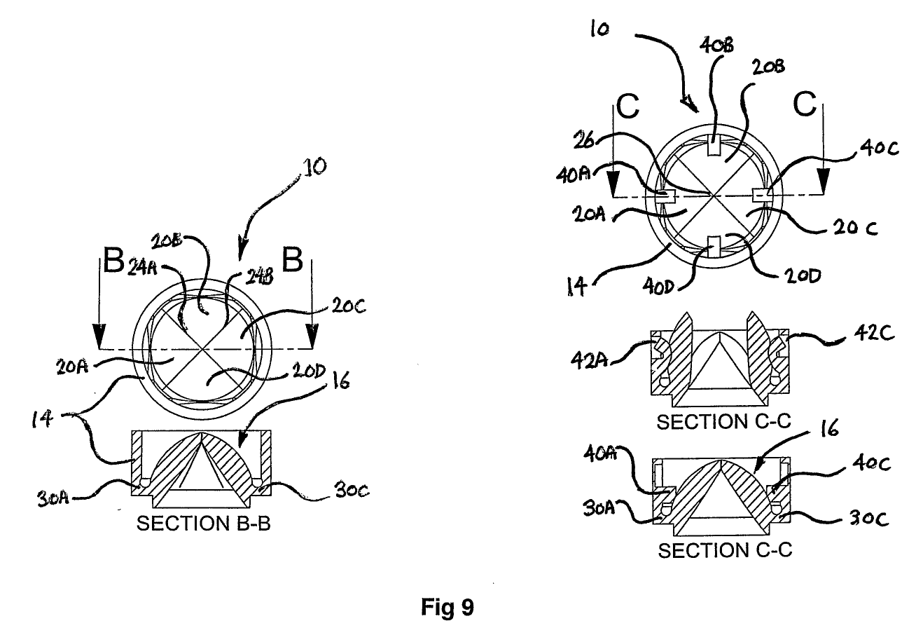

FIG. 9 illustrates a variant of the valves 10 and 100 of FIGS. 1 and 4, respectively. For ease of reference and in order to avoid repetition, like components of these alternative valves 10 have been designated with the same reference numeral as the valve of FIG. 1. The valve 10 shown on the left hand side is similar in design to the preceding embodiments. The other valve 10 shown on the right hand side includes a series of biasing elements or lugs 40A to 40D connected to, and protruding inwardly of, the valve body or skirt 14. These lugs such as 40A are each dedicated to and contact corresponding of the valve elements such as 20A. This contact between the lug and valve element, such as 40A and 20A, ensures that the valve remains closed at a relatively low differential pressures, for example up to 7 kPa. This means that the valve does not leakage at these relatively low differential pressures.

The alternate valve 10 of FIG. 9 also includes a series of recesses or undercuts 42A to 42D in the skirt 14. These undercuts such as 42A are of the same general shape as the corresponding lug such as 40A. The undercuts 42A also align with the lug 40A so that it can fold or otherwise deflect into the undercut 42A on opening of the valve. The lugs such as 40A may in this disposition fold partly within the skirt 14 whereby the valve elements such as 20A can fully opened without being restricted by the lugs 40A. The valve 10 thus allows increased flow through the passageway 18 with limited restriction by the valve elements such as 20A.

Now that several preferred embodiments of the present invention have been described in some detail it will be apparent to those skilled in the art that the valve has at least the following advantages over the admitted prior art:
1. the valve having a substantially straight resilient hinge can be opened at relatively low differential pressures across the valve member whilst being designed to provide relatively high backflow resistance;
2. the valve, and in particular the valve elements are subject to minimal stresses, and in particular tensions, on opening of the collapsible aperture which is preferably effected by a hinged movement of the valve element;
3. the valve and valve member is designed to provide a relatively large collapsible opening on opening of the valve where for example the collapsible opening in its open configuration exposes greater than 40% of the area of the fluid passageway of the valve;
4. the valve may be designed to remain closed and thus avoid leakage up to a minimum differential pressure, typically less than 10 kPa, when it opens; and
5. the valve is relatively simple to manufacture or fabricate in a preferred embodiment being of a one-piece construction and being mouldable in an elastomeric or polymeric material;

Those skilled in the art will appreciate that the invention described herein is susceptible to variations and modifications other than those specifically described. For example, the generally conical-shaped valve member may be truncated at or adjacent its apex wherein it is frusto-conical or alternately the valve member may be in the shape of a pyramid having resilient hinges at each of its respective base sides. The valve member may include variations on the dual slit configuration of the preferred embodiment provided the collapsible opening on opening provides minimal stress on the valve members.

All such variations and modifications are to be considered within the scope of the present invention the nature of which is to be determined on the foregoing description.

It is to be understood that any acknowledgement of prior art in this specification is not to be taken as an admission that this acknowledge prior art forms part of the common general knowledge in Australia or elsewhere.

1. A valve comprising:
a valve body including a fluid passageway and being adapted for mounting of the valve; and
a valve member connected to the valve body across the fluid passageway, the valve member including an opening defined by one or more valve elements being moveable relative to the valve body whereby opening and/or closure of the opening is effected by pivotal movement of said one or more valve elements about respective associated and substantially straight resilient hinges.

2. A valve as defined in claim 1, wherein the valve body is shaped substantially cylindrical and the valve member is symmetrical about the valve body.

3. A valve as defined in claim 1, wherein the valve member is in the form of a cone or conical-frustum, pyramid or pyramidal-frustum, being directed in a downstream flow direction.

4. A valve comprising:
a valve body including a fluid passageway and being adapted for mounting of the valve; and
a valve member connected to the valve body across the fluid passageway, the valve member including an opening which is exposed by bending of at least part of said member about an associated resilient hinge which provides minimal stressing of said member.

5. A valve as defined in claim 4, wherein the opening is defined by one or more valve elements being movable relative to the valve body.

6. A valve as defined in claim 1, wherein the valve member includes one or more slits dividing it into a plurality of said valve elements each being of a substantially identical configuration.

7. A valve as defined in claim 6, wherein each of the plurality of valve elements is arranged to bend or hinge about respective resilient hinges each adjoining the valve body and the valve member.

8. A valve as defined in claim 1, wherein the valve member includes two (2) of the slits arranged perpendicular to one another and intersecting at an axis of the valve body, the slits terminating at or adjacent opposite ends of the resilient hinge of the corresponding valve element.

9. A valve as defined in claim 8, wherein the resilient hinge is defined by an annular groove formed in the valve body and is of a thickness less than adjacent portions of the valve body and the valve member to provide preferential bending of the valve elements about their respective hinges.

10. A valve as defined in claim 8, wherein the thickness of the resilient hinge is tailored to allow opening of the valve at a minimum fluid pressure.

11. A valve as defined in claim 10, wherein the resilient hinge permits opening of the valve at a differential pressure of less than around 10% of the fluid static pressure.

12. A valve as defined in claim 5, wherein the valve member includes an annular seating portion being adapted to abut a corresponding surface of a valve housing whereby, on closure of the valve, further bending of said one or more valve elements is inhibited increasing the reverse flow resistance of the valve.

13. A valve as defined in claim 12, wherein the thickness of the valve member at the annular seating portion is at least two times the thickness of the resilient hinge.

14. A valve comprising:
a valve body including a fluid passageway and being adapted for mounting of the valve within a valve housing; and
a valve member connected to the valve body across the fluid passageway, the valve member including an opening defined by one or more valve elements being moveable relative to the valve body, the valve member also including a seating portion being adapted on closure of the valve to abut a corresponding surface of the valve housing whereby further movement of said one or more valve elements is inhibited increasing the reverse flow resistance of the valve.

15. A valve as defined in claim 14, wherein the seating portion is an annular seating portion.

16. A valve as defined in claim 1, wherein the valve elements are each tapered in thickness toward an apex of the valve member.

17. A valve as defined in claim 16, wherein the valve elements are flared or bulged inwardly toward the axis of the valve body.

18. A valve as defined in claim 1, also comprising one or more biasing elements each connected to the valve body and arranged on closure of the valve to contact the valve member for sealing closure at relatively low differential pressures.

19. A valve as defined in claim 18, wherein the biasing element is in the form of a lug connected to and projecting inwardly of the valve body, the lug being aligned with a corresponding recess in the valve body.

20. A valve as defined in claim 19, wherein the lug at least in part deflects into the recess on opening of the valve.

21. A valve as defined in claim 1, wherein the opening is a collapsible opening.

22. A valve as defined in claim 1, wherein the valve member when open defines a throat representing greater than around 40% of the area of the fluid passageway.

23. A valve as defined in claim 1, wherein the valve member is in the form of a cone or conical-frustum, pyramid or pyramidal-frustum, being directed in a downstream flow direction.

24. A valve as defined in claim 1, wherein the valve is a non-return valve, check valve, or backflow prevention valve.

25. A valve as defined in claim 1, wherein the valve is a one-piece moulding being constructed or fabricated of an elastomeric or polymeric material.
